(19) United States
(12) Patent Application Publication
(10) Pub. No.: US 2016/0069465 A1
(43) Pub. Date: Mar. 10, 2016

(54) HYDRAULIC CONTROL VALVE AND HYDRAULIC CONTROL DEVICE

(71) Applicant: TOYOTA JIDOSHA KABUSHIKI KAISHA, Toyota-shi, Aichi (JP)

(72) Inventor: Yuji SUZUKI, Toyota-shi (JP)

(73) Assignee: TOYOTA JIDOSHA KABUSHIKI KAISHA, Toyota-shi, Aichi (JP)

(21) Appl. No.: 14/785,244

(22) PCT Filed: Apr. 17, 2013
(86) PCT No.: PCT/JP2013/061429

§ 371 Date: Oct. 16, 2015

(51) Int. Cl. F16K 31/06; F16K 31/124; F16K 3/02

(52) U.S. Cl. CPC F16K 31/0644; F16K 3/0254; F16K 31/124

(57) ABSTRACT

A hydraulic control valve includes a piston held in a cylinder and reciprocatable, a positive pressure chamber formed on one side of the piston and connected to an inlet port and an outlet port, a back pressure chamber formed on another side of the piston, a valve element formed on the piston to open and close the outlet port, an orifice arranged between the positive chamber and back chamber, and a pilot valve selectively providing a connection between the back chamber and a site having a pressure lower than that in the back chamber. The inlet port is connected to a high pressure site, and the outlet port is connected to a low pressure site having a pressure lower than that in the high pressure site. The control valve includes an orifice adjustment device adjusting an opening degree of the orifice based on a pressure drop in the back chamber.

### TECHNICAL FIELD

The present invention relates generally to a valve for controlling delivery and discharge of oil, and more specifically, to a control valve for selectively enabling and disabling delivery and discharge of oil to/from a control object by opening or closing a port and a hydraulic control device having the control valve.

### BACKGROUND ART

Hydraulic pressure in an actuator is adjusted to a required level by repeatedly delivering pressurized oil regulated to a required level thereto and discharging the oil therefrom. For example, pressure of the oil is regulated by applying a feedback pressure as an output pressure to a valve element. To this end, a large electromagnetic coil is not required to establish a load or a pressure for setting a regulation level. However, in case of controlling hydraulic pressure in the actuator using an on-off valve, a valve element of the on-off valve is subjected to feeding pressure or a pressure from the control object. In this case, if an electromagnetic valve is used as the on-off valve, a large electromagnetic coil is required to establish a thrust force counteracting the feeding pressure. In addition, a response of the valve may be unsatisfactory.

Japanese Patent Laid-Open No. 2011-163508 describes a valve adapted to solve the above-explained disadvantage and a hydraulic control device using this valve. The hydraulic control device is applied to a belt-driven continuously variable transmission, and a balance piston type solenoid valve is used to control hydraulic pressure in a pulley on which a belt is applied. In the solenoid valve, a piston integrated with a needle-shaped or shaft-shaped valve element is held in a cylinder while being allowed to reciprocate in an axial direction. An inlet port and an outlet port are formed in the chamber (as will be tentatively called the “positive pressure chamber”) holding the piston, and the inlet port is connected to a high pressure site and the outlet port is connected to a low pressure site. The solenoid valve is closed by pushing the valve element onto an opening end of the hydraulic chamber side of the outlet port. The hydraulic chamber is connected to an opposite chamber (as will be tentatively called the “control chamber”) across the piston through a communication passage on which an orifice is formed. The control chamber is also connected to the low pressure site and a solenoid (as will be called the “pilot valve” hereinafter) is arranged in the control chamber to selectively provide a communication between the control chamber and the low pressure site. Specifically, pressure in the control chamber is lowered by opening the pilot valve so that the piston is withdrawn from a valve seat toward the control chamber to open the valve. By contrast, pressure in the control chamber is raised by closing the pilot valve so that the piston is pushed onto the valve seat to close the outlet port thereby closing the valve.

In the above-mentioned balance piston solenoid valve, a balance between pressures in the positive pressure chamber and the control chamber across a piston serving as a main valve is kept by a pilot valve, and the solenoid valve is opened and closed by losing the balance therebetween by the pilot valve. That is, the pilot valve is adapted to selectively provide a communication between the control chamber and the low pressure site, but it is not required to deliver the oil to the control object and to ensure an oil discharging rate from the control object sufficiently. Therefore, small valve can be used and a response of the valve can be improved.

Here will be explained an action of the balance piston solenoid valve. As described, the pressure in the hydraulic chamber is governed by a discharging amount from the pilot valve and a delivery amount thereto through a control orifice, as expressed by the following expression:

P2=P1·A₁²/(A₁²+A₂²)+P3·A₂²/A₁²/(A₁²+A₂²)

where “P1” is a delivery amount to the positive pressure chamber (i.e., an upstream pressure), “P2” is a pressure in the control chamber (i.e., a control pressure), “P3” is a pressure (i.e., a downstream pressure) in the control object (i.e., the low pressure site), “A1” is a cross-sectional area of the control orifice, and “A2” is an opening area of the pilot valve. Specifically, the control pressure P2 is lowered by increasing the opening degree of the pilot valve. Consequently, a difference between the pressure in the control chamber (i.e., the control pressure), and the pressure in the positive pressure chamber (i.e., the upstream pressure) is widened so that the main valve is withdrawn to increase the opening degree.

A relation between the opening degree of the pilot valve and a ratio of the control pressure to the upstream pressure (control pressure/upstream pressure) is shown in FIG. 14. When the pilot valve is opened to discharge oil from the control chamber, the ratio of the control pressure to the upstream pressure is decreased so that a thrust force for withdrawing the piston integrated with the valve element is established. Then, when the thrust force exceeds an elastic force of the spring (at point O1 in FIG. 14), the piston is withdrawn to open the valve. Consequently, the control pressure the control pressure is lowered with an increase in the opening degree of the pilot valve so that the opening degree of the main valve is increased to be fully opened at point O2 in FIG. 14. As can be seen from FIG. 14, the ratio of the control pressure to the upstream pressure is decreased abruptly when the opening degree of the pilot valve is small. The main valve is opened in accordance with such ratio, and hence the main valve is opened too widely to increase a flow rate excessively even if the pilot valve is opened slightly. That is, even if a control amount of the flow rate is small, the main valve is control in a same manner as a case in which the control gain is large. Consequently, controllability of the valve may be deteriorated.

In addition, when the opening degree of the pilot valve opened slightly is increased slightly as shown in FIG. 14, the ratio of the control pressure to the upstream pressure is decreased significantly. Consequently, the main valve will be opened completely even if the opening degree off the pilot valve is still narrow. As a result, an opening range of the pilot valve controlling the opening degree of the main valve would be narrowed to worsen the controllability of the valve.

### DISCLOSURE OF THE INVENTION

The present invention has been conceived noting the foregoing technical problem, and it is therefore an object of the present invention is to improve controllability of a balance piston type hydraulic control valve and a hydraulic control device using this kind of valve.

The hydraulic control valve according to the present invention comprises: a piston held in a cylinder while being allowed to reciprocate in an axial direction; a positive pressure chamber formed on one side of the piston in the cylinder while being connected to a first inlet port and a first outlet port; a back pressure chamber formed on the other side of the piston; a valve element formed on the piston to open and close the first outlet port; an orifice arranged between the positive pressure chamber and the back pressure chamber; and a pilot valve that selectively provides a connection between the back pressure chamber and a site at which pressure therein is lower than that in the back pressure chamber. In the hydraulic control valve, the first inlet port is connected to a high pressure site, and the first outlet port is connected to a low pressure site at which a pressure therein is lower than that in the high pressure site. In order to achieve the above-explained objectives, according to the present invention, the hydraulic control valve is provided with an orifice adjustment device that adjusts an opening degree of the orifice based on a condition of pressure drop in the back pressure chamber.

The orifice adjustment device may be adapted to reduce restriction of oil by the orifice with an increase in a pressure difference between the back pressure chamber and the positive pressure chamber.

According to one aspect of the present invention, the orifice adjustment device comprises: a first port connected to the positive pressure chamber; a second port connected to the back pressure chamber; and an adjuster valve element to which pressures from the positive pressure chamber and the back pressure chamber are applied to counteract each other, and which is moved upon exceedance of a difference between the pressures applied thereto to increase an opening area of the first port or the second port in accordance with the pressure difference. In this case, any of the first port and the second port serves as the orifice, and an opening area thereof may be changed by the adjuster valve element.

The pilot valve comprises: a plunger that is axially reciprocated by an electromagnetic force; a pilot cylinder holding the plunger therein; a second inlet port that is opened to an inner circumferential face of the pilot cylinder while being connected to the back pressure chamber; a second outlet port that is opened to one of axial ends of the pilot cylinder while being connected to the low pressure site, and that is opened and closed by the plunger; and a third port that is opened to the inner circumferential face of the pilot cylinder while being connected to the positive pressure chamber. The orifice may be formed by partially overlapping the plunger with any one of the second inlet port and the third port to reduce an opening degree thereof. In this case, the orifice adjustment device reduces the opening degree of the orifice by axially moving the plunger overlapped partially with any one of the second inlet port and the third port.

An opening width of any one of said ports may differ in an reciprocating direction of the plunger.

According to another aspect of the present invention, wherein the pilot valve comprises: a plunger that is axially reciprocated by an electromagnetic force; a pilot cylinder holding the plunger therein; a third inlet port that is opened to an inner circumferential face of the pilot cylinder while being connected to the back pressure chamber; a third outlet port that is opened to one of axial ends of the pilot cylinder while being connected to the low pressure site, and that is opened and closed by the plunger; and a fourth port that is opened to the inner circumferential face of the pilot cylinder while being connected to the positive pressure chamber. In this case, a clearance between a portion of the inner circumferential face of the pilot cylinder and a portion of the outer circumferential face of the plunger may serve as the orifice between the third inlet port and the fourth port, and the orifice adjustment device changes a length of the clearance by axially moving the plunger.

The hydraulic control valve further comprises another orifice adapted to restrict a flow rate of oil flowing into the positive pressure chamber from the high pressure site through the first inlet port. Structure of such another orifice will be explained hereinafter.

In the hydraulic control valve according to the present invention, the piston and the valve element are allowed to be moved between a position to fully close the first outlet port and a position to fully open the first outlet port. Said another orifice is adapted to restrict a flow rate of the oil flowing into the positive pressure chamber from the first inlet port within a predetermined range before the piston and the valve element reach the position to fully open the first outlet port. In addition, when the piston and the valve are moved further than the predetermined range, said another orifice will not restrict a flow rate of the oil flowing into the positive pressure chamber from the first inlet port.

Another orifice may also be adapted to reduce restriction of the oil by increasing an opening degree thereof in accordance with a traveling distance of the piston and the valve element in a direction to open the first outlet port.

Another orifice may also be adapted to be fully opened so as not to restrict a flow rate of the oil by moving the piston and the valve element predetermined distance in the direction to open the first outlet port.

Another orifice may be a clearance formed between the outer circumferential face of the piston and the inner circumferential face of the cylinder that allows the oil to flow therethrough toward the positive pressure chamber.

The piston comprises a base portion that is brought into contact to the inner circumferential face of the cylinder in a liquid-tight manner, and a protruding portion that is diametrically smaller than the base portion and that protrudes from the base portion toward the positive pressure chamber. The positive pressure chamber may comprise a diametrically smaller portion that is overlapped with a leading end portion of the protruding portion within a predetermined range. In addition, another orifice may be formed between an outer circumferential face of the protruding portion and an inner circumferential face of the diametrically smaller portion.

An overlap zone between the protruding portion and the diametrically smaller portion may be shorter than the travel distance of the piston and the valve element from the position to fully close the first outlet port and the position to fully open the first outlet port.

Another orifice may also be formed by an opening end of the first inlet port opening to the positive pressure chamber, and the outer circumferential face of the piston that is partially overlapped with the opening end to reduce an opening area of the opening end. In addition, an opening width of the opening end in a circumferential direction of the cylinder may differ in an axial direction of the cylinder.

Another orifice may also be a groove that is formed on the outer circumferential face of the piston while being opened to the first inlet port and the positive pressure chamber.

Another orifice includes a through hole penetrating through the piston while being opened to the first inlet port and the positive pressure chamber.

According to still another aspect of the present invention, there is provided a hydraulic control device comprising a feeding valve that controls oil delivered from a hydraulic source to a hydraulic chamber of a pulley on which a belt is applied, and a discharging valve that controls the oil discharged from the hydraulic chamber. In the hydraulic control device, the aforementioned the hydraulic control valve used as at least any of the feeding valve and the discharging valve.

Thus, in the hydraulic control valve according to the present invention, an opening degree of the orifice arranged between the positive pressure chamber and the back pressure chamber is varied in accordance with a condition of pressure drop in the back pressure chamber in such a manner to relax the restriction of the flow rate of the oil when the back pressure chamber is connected to the low pressure site by the pilot valve to discharge the oil. Therefore, an increment of a pressure difference between the positive pressure chamber and the back pressure chamber resulting from an increment of opening degree of the pilot valve, or a reduction of a ratio between pressures in those chambers can be suppressed. For this reason, in the hydraulic control valve of the present invention, the opening degree of the pilot valve to the position of the valve element of the piston to open the pilot valve completely can be widened. In addition, pressure drop in the back pressure chamber with respect to an opening degree of the pilot valve when the opening degree is small can be reduced. As a result, according to the present invention, controllability of the hydraulic control valve cam be improved.

In addition, according to the present invention, an opening degree of the orifice may be varied by moving the plunger of the pilot valve in the axial direction. In this case, the controllability of the hydraulic control valve can be improved by damping an impact of fluctuation in an initial pressure established by the hydraulic source connected to the positive pressure chamber.

To this end, an opening width of the port may be changed in accordance with a position of the plunger. Consequently, reduction in the pressure in the back pressure chamber with respect to the opening degree of the pilot valve, or a ratio between the pressures in the positive pressure chamber and the back pressure chamber may be changed according to need. Therefore, the controllability of the hydraulic control valve can be further improved.

In addition, according to the present invention, pressure rise in the positive pressure chamber or a travelling velocity of the piston integrated with the valve element can be suppressed. For this reason, an opening degree of the pilot valve used to control hydraulic pressure can be further widened so that the controllability of the hydraulic control valve can be further improved.

### BRIEF DESCRIPTION OF THE DRAWINGS

FIG. 1 is a cross-sectional view showing one example of the hydraulic control valve according to the present invention.

FIG. 2 is a cross-sectional view of the spool valve serving as an orifice in which (a) shows a situation where pressure in the back pressure chamber is high, (b) shows a situation where pressure in the back pressure chamber is at a medium level, and (c) shows a situation where pressure in the back pressure chamber is low.

FIG. 3 is a graph showing a relation between stroke of the spool and opening area of the orifice.

FIG. 4 is a graph showing a relation between opening degree of the pilot valve and pressure in the back pressure chamber.

FIG. 5 is a cross-sectional view showing another example of the hydraulic control valve according to the present invention in which the pilot valve serves as a variable orifice.

FIG. 6 is a schematic illustration showing a situation of the pilot valve when it is not energized, in which (a) is a cross-sectional view, and (b) is a plan view showing positions of the plunger and the third port.

FIG. 7 is a schematic illustration showing a situation of the pilot valve when it is energized, in which (a) is a cross-sectional view, and (b) is a plan view showing positions of the plunger and the third port.

FIG. 8 is a schematic illustration of the third port showing modifications of configuration of the third port.

FIG. 9 is a schematic illustration showing a situation of the pilot valve in which a groove is formed on the plunger when it is not energized, in which (a) is a cross-sectional view, and (b) is a plan view showing positions of the plunger and the third port.

FIG. 10 is a schematic illustration showing a situation of the pilot valve in which a groove is formed on the plunger when it is energized, in which (a) is a cross-sectional view, and (b) is a plan view showing positions of the plunger and the third port.

FIG. 11 is a cross-sectional view showing still another example of the hydraulic control valve according to the present invention.

FIG. 12 is a partial cross-sectional view of the orifice.

FIG. 13 is a hydraulic circuit schematically showing one example of the hydraulic control device according to the present invention.

FIG. 14 is a graph showing a change in a ratio between pressures in the back pressure chamber and the positive pressure chamber with respect to an opening degree of the pilot valve.

FIG. 15 is a cross-sectional view showing an example in which the main valve is provided with another orifice.

FIG. 16 is a partial cross-sectional view showing a clearance serving as an orifice.

FIG. 17 is a cross-sectional view showing another example of another orifice arranged in the main valve.

FIG. 18 is a graph showing a relation between stroke of the piston integrated with the valve element and pressure in the positive pressure chamber in both cases in which upstream pressure is high and in which upstream pressure is low.

FIG. 19 is a graph showing a relation between opening area of the solenoid valve and back pressure in both cases in which upstream pressure is high and pressure difference is large, and in which upstream pressure is low and pressure difference is small.

FIG. 20 is a graph showing a relation between a current value applied to the solenoid valve and a flow rate.

FIG. 21 is a graph showing a relation between stroke of the valve element of the main valve and control pressure in both cases in which the clearance serving as an orifice is available, and in which the clearance serving as an orifice is not available.

FIG. 22 is a graph showing a change in the ratio between the pressures in the back pressure chamber and the positive pressure chamber with respect to an opening degree of the pilot valve in both cases in which the clearance serving as an orifice is available, and in which the clearance serving as an orifice is not available.

### DETAILED DESCRIPTION OF THE PREFERRED EMBODIMENT(S)

The hydraulic control valve according to the present invention is categorized into a balance piston type solenoid valve that is characterized by an adjuster device for changing an opening degree of a control orifice. Specifically, the hydraulic control valve according to the present invention comprises a main valve for delivering and discharging oil to/from a control object, and a pilot valve for actuating the main valve. In the main valve, an opening degree of the control orifice is changed to restrict an oil flow to a back pressure chamber opened and closed by the pilot valve.

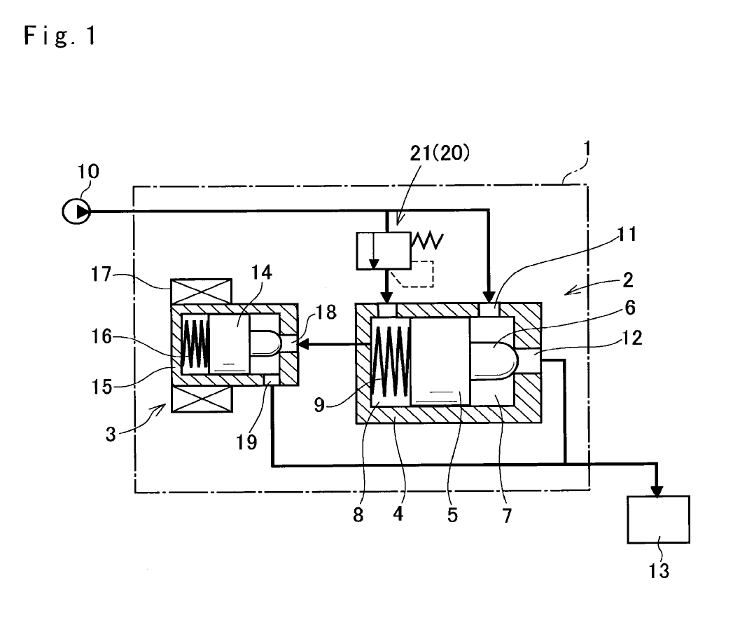

Referring now to FIG. 1, there is shown one example of the hydraulic control valve according to the present invention. In the hydraulic control valve 1, fundamental structures of a main valve 2 and a pilot valve 3 are similar to those of the conventional art. First of all, structure of the main valve 2 will be explained. A piston 5 is held in a liquid-tight cylinder 5 while being allowed to reciprocate in an axial direction, and a valve element 6 is integrated with the piston 5. Specifically, the valve element 6 is a shaft member, and a leading end thereof is rounded.

That is, an internal space of the cylinder 4 is divided by the piston 5 into a positive pressure chamber 7 holding the valve element 6 and a back pressure chamber 8 in an opposite side. In the back pressure chamber 8, a spring 9 is arranged to push the piston 5 toward the positive pressure chamber 7. An inlet port 11 to which the oil from a hydraulic source 10 is delivered and an outlet port 12 from which the oil is discharged are formed in the positive pressure chamber 7. Specifically, the inlet port 11 is formed to penetrate the cylinder 4, and the outlet port 12 is formed to penetrate an end plate covering a leading end of the valve element 6 so that the outlet port 12 is closed by pushing the leading end of the valve element 6 thereto. That is, an opening end of the outlet port 12 serves as a valve seat so that the outlet port 12 is closed by pushing the leading end of the valve element 6 onto the opening end. The t the outlet port 12 is also connected to a control object 13.

The hydraulic source 10 includes an oil pump, an oil passage for a line pressure established by regulating pressure generated by the oil pump, and an accumulator accumulating a predetermined pressure. The control object 13 includes a site in which a pressure therein is controlled by an initial pressure established by the hydraulic source such as an actuator. Accordingly, the hydraulic source 10 corresponds to the claimed high pressure site, and the control object 13 corresponds to the claimed low pressure site. In case the hydraulic control valve 1 is used as a discharging valve to control pressure in a predetermined actuator by discharging oil therefrom, the actuator serves as the claimed high pressure site, and the drain site serves as the claimed low pressure site.

The pilot valve 3 is connected to the back pressure chamber 8, and adapted to open and close a passage providing a connection between the back pressure chamber 8 and the control object 13 as the low pressure site. Specifically, the pilot valve 3 is a conventional electromagnetic on-off valve in which a port is opened and closed by reciprocating a plunger 14 by an electromagnetic force. The plunger 14 is held in a liquid-tight pilot cylinder 15 while being allowed to reciprocate in an axial direction, and a spring 16 is arranged on a rear side (i.e., on a back side) of the plunger 14 to push the plunger 14 in the axial direction. In addition, an electromagnetic coil 17 is arranged around the pilot cylinder 15 at a rear end side of the plunger 14. In the pilot valve 13, therefore, an electromagnetic force is generated by energizing the electromagnetic coil 17, and the plunger 14 is withdrawn by a thrust force derived from the electromagnetic force to counteract an elastic force of the spring 16 when the thrust force overwhelms the elastic force.

An inlet port 18 is formed on an end plate of the pilot cylinder 15 covering a leading end of the plunger 14. That is, the plunger 14 also serves as a valve element so that the inlet port 18 is closed by pushing the leading end of the plunger 14 onto an inner opening of the inlet port 18, and opened by withdrawing the plunger 14 therefrom. The inlet port 18 is also connected to the back pressure chamber 8 of the main valve 2. Although the inlet port 18 is connected to the back pressure chamber 8 through an oil passage in FIG. 1, the inlet port 18 may also be connected directly to the back pressure chamber 8 e.g., by integrating the pilot cylinder 15 with the cylinder 4 of the main valve 2. An outlet port 19 is also formed on a cylindrical portion of the pilot cylinder 15 at a portion to be connected to the low pressure site such as the control object 13. Thus, the pilot valve 3 is opened to provide a communication between the back pressure chamber 8 and the low pressure site such as the control object 13 so as to discharge the oil from the back pressure chamber 8.

In the main valve 2, the positive pressure chamber 7 is connected to the back pressure chamber 8 through an orifice 20 in which an opening degree thereof is adjustable. Specifically, the orifice 20 is adapted to equalize pressures in the positive pressure chamber 7 and the back pressure chamber 8 when the pilot valve 3 is closed, and to create a pressure difference between the positive pressure chamber 7 and the back pressure chamber 8 by restricting a delivery amount of the oil to the back pressure chamber 8 when the pilot valve 3 is opened to discharge the oil from the back pressure chamber 8. To this end, the back pressure chamber 8 is connected to the hydraulic source 10 through the orifice 20, and the positive pressure chamber 7 is also connected to the hydraulic source 10. Thus, the positive pressure chamber 7 and the back pressure chamber 8 are connected to each other through the orifice 20.

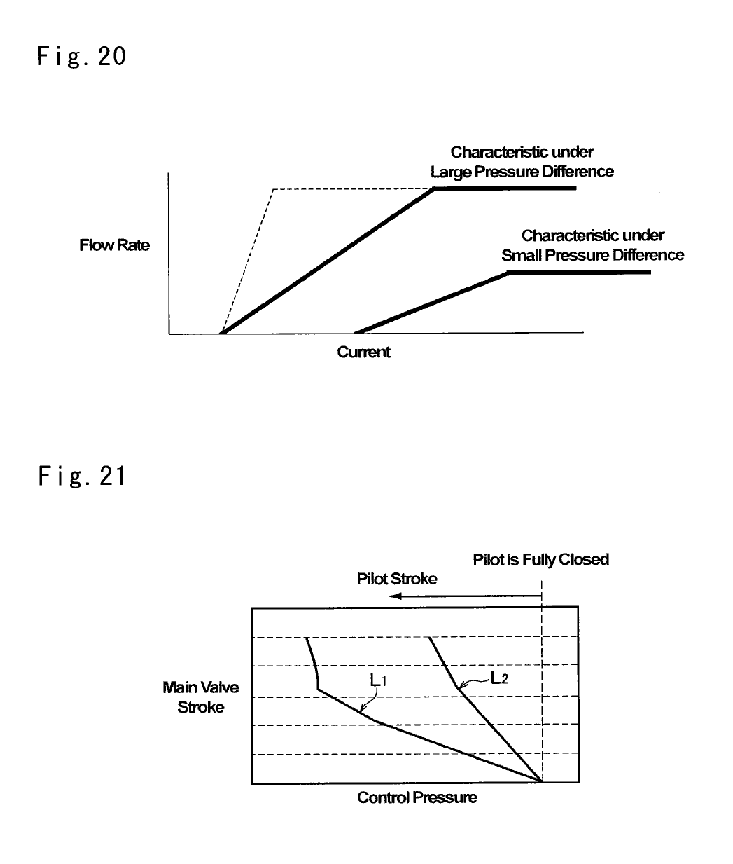

An opening degree of the orifice 20 is adjusted in accordance with a pressure drop in the back pressure chamber 8. Specifically, the orifice 20 is opened widely when the pressure in the back pressure chamber drops significantly as compared to a case in which the pressure in the back pressure chamber drops slightly. An example of the orifice 20 and an opening degree adjustment device are shown in FIG. 20. In the example shown therein, a spool valve 21 is used to serve as the orifice 20 and the opening degree adjustment device. In the spool valve 21, a spool comprising land portions 22a and 22b having same outer diameters is held in a cylinder 23 while being allowed to reciprocate in an axial direction. Accordingly, the spool 22 serves as the claimed adjuster valve element, and a spring 24 is arranged on one end of the spool 22 to push the spool 22 in the axial direction.

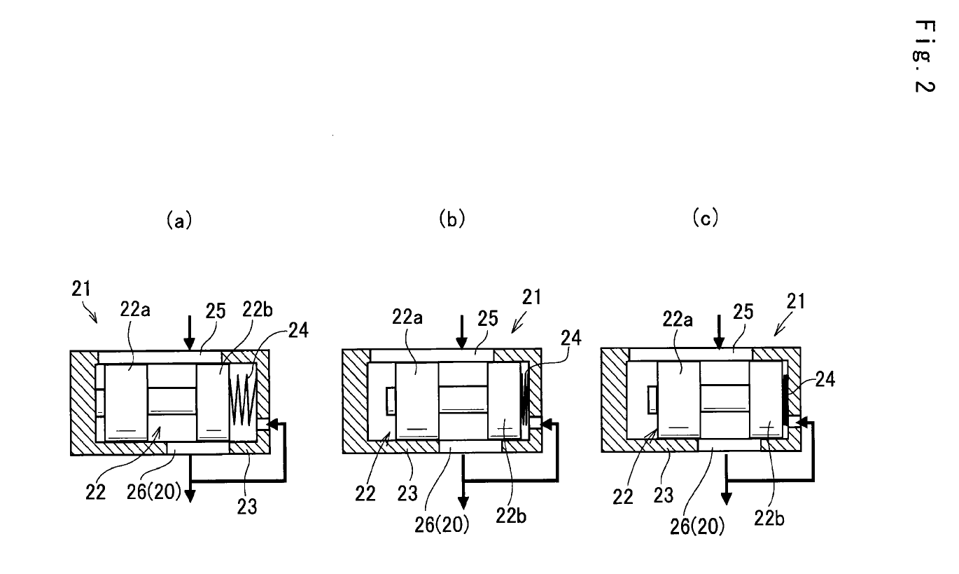

An inlet port 25 serving as the claimed first port and an outlet port 26 serving as the claimed second port are formed on the cylinder 23. The inlet port 25 is connected to the above-mentioned back pressure chamber 8 or hydraulic source 10. The inlet port 25 also serves as a signal pressure port. To this end, the inlet port 25 is always opened to a stem between the land portions 22a and 22b from the land portion 22b pushed by the spring 24 to an end side of the land portion 22a. That is, the pressure from the hydraulic source 10 or the positive pressure chamber 7 is applied to the spring 22 to counteract an elastic force of the spring 24. On the other hand, the outlet port 26 is opened within a reciprocating region of the land portion 22b so that the land portion 22b is always overlapped at least partially therewith, and the outlet port 26 is connected to the back pressure chamber 8. Specifically, an overlap zone between the land portion 22b and the outlet port 26 is increased when the spool 22 is pushed by the spring 24, and the overlap zone therebetween is reduced when the spool 22 is withdrawn while compressing the spring 24. For example, when the spool 22 is situated at the most anterior point, approximately half area of the outlet port 26 is closed by the land portion 22b. By contrast, the aforementioned overlap zone is decreased with the withdrawal of the spool 22 so that the opening area of the outlet port 26 is increased. Thus, according to the example shown in FIG. 2, the outlet port 26 serves as an orifice in which an opening degree thereof is changed depending on a position of the spool 22. In addition, a feedback pressure from the outlet port 26 is applied to the back face of the land portion 22b pushed by the spring 24.

Next, an action of the hydraulic control valve 1 will be explained hereinafter. When the electromagnetic coil 17 of the pilot valve 3 is unenergized so that the hydraulic control valve 1 is in off state, the back pressure chamber 8 of the main valve 2 is closed and the pressure therein is equalized to that in the positive pressure chamber 7. In the main valve 2, since the valve element 6 is formed on a face of the piston 5 facing to the positive pressure chamber 7, a pressure receiving area of a face of the poison 5 facing to the back pressure chamber 8 is larger than that of the face facing to the positive pressure chamber 7. That is, given that the pressures in the back pressure chamber 8 and the positive pressure chamber 7 are equal to each other, a thrust force is established by such pressure difference in the direction to push the piston 5 toward the positive pressure chamber 7. In this situation, the valve element 6v is pushed onto the opening of the outlet port 12 by the thrust force so that the main valve 2 is closed.

In the spool valve 21 serving as the variable orifice, pressures in both sides of the spool 22 are equal to each other, and pressure receiving areas (i.e., face areas) of the land portions 22a and 22b are also equal to each other. Therefore, the spool 22 is not moved axially by a pressure difference but pushed by an elastic force of the spring 22. In this situation, specifically, the spool 22 is pushed to the most anterior point as shown in FIG. 2 (a) and hence the outlet port 26 is closed to a maximum extent, that is, an opening degree of the orifice 20 is reduced to the minimum degree.

When the electromagnetic coil 17 is energized, an electromagnetic force is applied to the plunger 14 in accordance with a current value. Then, when the thrust force established by the electromagnetic force overwhelms the elastic force of the spring 16, the plunger 14 starts withdrawing. That is, the pilot valve 3 starts opening. Since the pilot valve 3 is connected to the low pressure site such as the control object 13, the oil is discharged from the back pressure chamber 8 of the main valve 2 by thus opening the pilot valve 3. Consequently, the pressure in the back pressure chamber 8 is differentiated from that in the positive pressure chamber 7, and when the thrust force derived from such pressure difference exceeds the elastic force of the spring 9, the piston 5 is withdrawn to open the main valve 2. As a result, the oil from the hydraulic source 10 is allowed to be delivered to the low pressure site such as the control object 13 through the main valve 2.

When the pressure in the back pressure chamber 8 is thus lowered, the oil flows from the positive pressure chamber 7 or the hydraulic source 10 toward the back pressure chamber 8. In this situation, however, an amount of the oil flowing into the back pressure chamber 8 is restricted by the orifice 20. The pressure in the back pressure chamber 8 in this situation can be expressed by the above-mentioned expression. That is, the pressure difference between the back pressure chamber 8 and the positive pressure chamber 7 or a ratio therebetween is adjusted in accordance with the opening degree of the pilot valve 3.

In this situation, in the spool valve 21, a pressure applied to the end face of the land portion 22b pushed by the spring 24 is lowered. That is, the pressure difference between both sides of the spool 22 is widened. When the thrust force axially pushing the spool 22 derived from such pressure difference exceeds the elastic force of the spring 24, the spool 22 is pushed toward the spring 24 while compressing the spring 24. Consequently, the an overlap zone between the land portion 22b and the outlet port 26 is decreased to increase the opening area of the outlet port 26. That is, an opening degree of the orifice 20 is increased.

When the current valve applied to the electromagnetic coil 17 is further increased to increase the opening degree of the pilot valve 3, the pressure in the back pressure chamber 8 is further lowered so that the pressure pushing the spool 22 cooperatively with the spring 24 is further lowered. Eventually, the spool 22 is pushed to the most posterior point of the spring 24 side as shown in FIG. 2 (c). In this situation, the opening area of the outlet port 26 is enlarged to the maximum extent so that the opening degree of the orifice 20 is widened to the maximum degree.

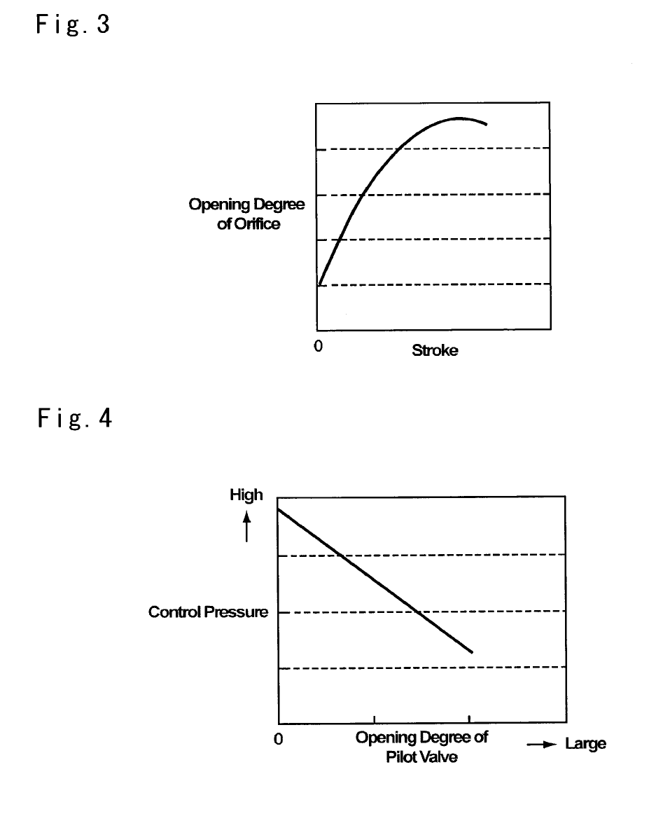

Thus, the opening degree of the pilot valve 3 is increased by increasing the current value applied to the electromagnetic coil 17 so that the pressure in the back pressure chamber 8 is lowered, and the opening degree of the orifice 20 is increased with such pressure drop in the back pressure chamber 8. Consequently, an amount of the oil flowing into the back pressure chamber 8 from the positive pressure chamber 7 or the hydraulic source is increased. In this situation, a reduction rate of the pressure in the back pressure chamber 8 is reduced in comparison with that of a case in which the opening degree of the orifice 20 is kept to a constant degree. An example of such situation is shown in FIG. 3. Specifically, FIG. 3 shows a relation between a stroke of the spool 22 and an opening degree of the orifice 20. When the spool 22 is situated at the most anterior point as shown in FIG. 2(a), that is, the stroke thereof is “0”, an opening area of the orifice 20 is reduced to a designed value. When the spool 22 is moved in the direction to compress the spring 24, the opening area of the orifice 20 is increased with an increase in the stroke of the spool 22, and eventually the opening area of the orifice 22 is increased to the maximum area when the spool 22 is moved to the most posterior point. In the example shown in FIG. 3, an increasing rate or tendency is set exponentially. However, the increasing rate may be adjusted arbitrarily in accordance with a configuration of the opening of the outlet port 26.

FIG. 4 shows a relation between the opening degree of the pilot valve 3 governing the opening degree of the orifice 20 and the pressure in the back pressure chamber 8 (i.e., as will be also called the “control pressure”). As described, the control pressure is lowered with an increase in the current value applied to the electromagnetic coil 17. However, an opening degree of the orifice 20 is increased with a reduction of the control pressure so that an amount of the oil flowing into the back pressure chamber 8 is increased. Consequently, a reduction rate or degree of the control pressure with respect to a change (i.e., an increment) in the current value applied to the electromagnetic coil 17 or the opening degree of the pilot valve 3 is reduced in comparison with that of the case in which the opening degree of the orifice is kept to a constant degree. Therefore, as shown in FIG. 4, the control pressure is lowered linearly or inversely proportional to an increase in the opening degree of the pilot valve 3.

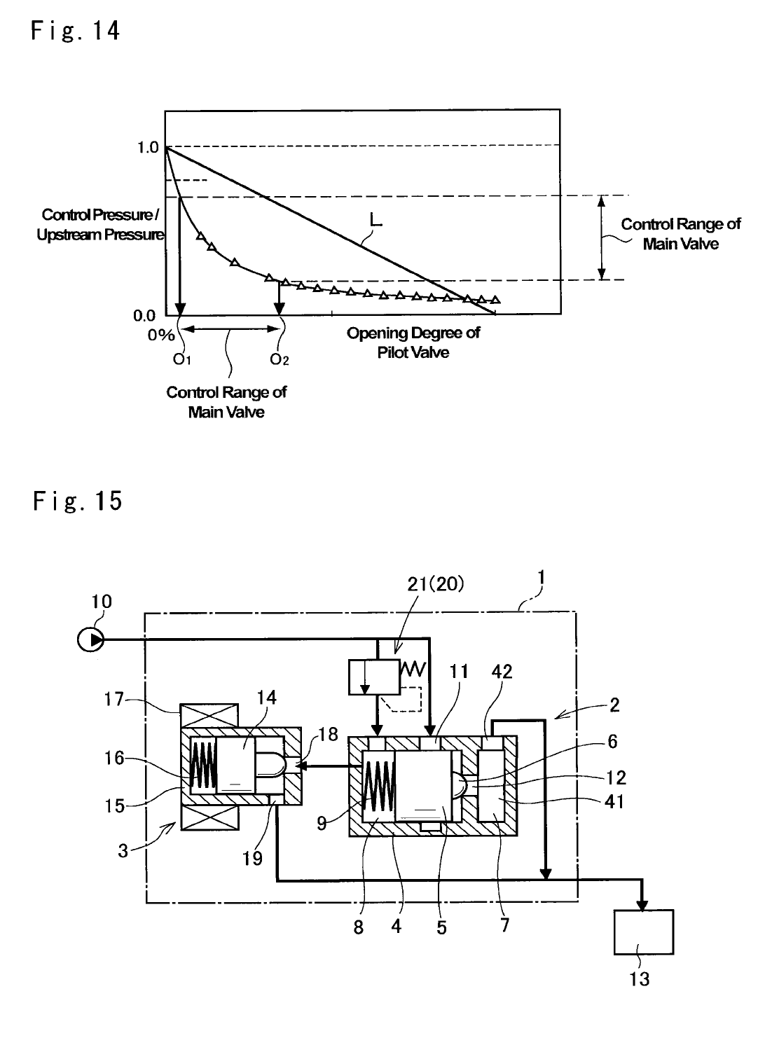

Given that the pressure in the high pressure site such as the hydraulic source 10 is constant, an opening degree of the main valve 2 is changed in accordance with the control pressure in the back pressure chamber 8. Therefore, given that the control pressure is changed inversely proportional to an increase in the opening degree of the pilot valve 3, the ratio of the control pressure to the upstream pressure (control pressure/upstream pressure) is also reduced inversely proportional to an increase in the opening degree of the pilot valve 3. Turning back to FIG. 14, the straight line L shown therein represents such inversely proportional relation between the opening degree of the pilot valve 3 and the ratio of the control pressure to the upstream pressure (control pressure/upstream pressure). It is rather difficult to adjust the relation between the opening degree of the pilot valve 3 and the ratio of the control pressure to the upstream pressure (control pressure/upstream pressure) to the relation represented by the straight line L even if the opening degree of the orifice 20 is changed by the above-explained manner. However, according to the preferred example, such relation can be approximated to the relation represented by the straight line L. In the hydraulic control valve 1, therefore, an amount of change in the opening degree of the main valve 2 or the control pressure with respect to an amount of change in the opening degree of the pilot valve 3 under a condition that the opening degree of the pilot valve 3 is small or that a control amount of the pressure in the control object 13 is small is reduced in comparison with the case in which the opening degree of the orifice is kept to a constant degree. For example, this is applied to a valve in which a control gain is small, and controllability of such valve can be improved while preventing an overshooting and a hunting of the pressure in the control object. In addition, as can be seen from FIG. 14, a maximum opening degree of the pilot valve 3 within an operating range of the main valve 2 is increased in comparison with the case in which the opening degree of the orifice is kept to a constant degree. This means that a range of opening degree of the pilot valve 3 or a control current value is widened to further improving the controllability.

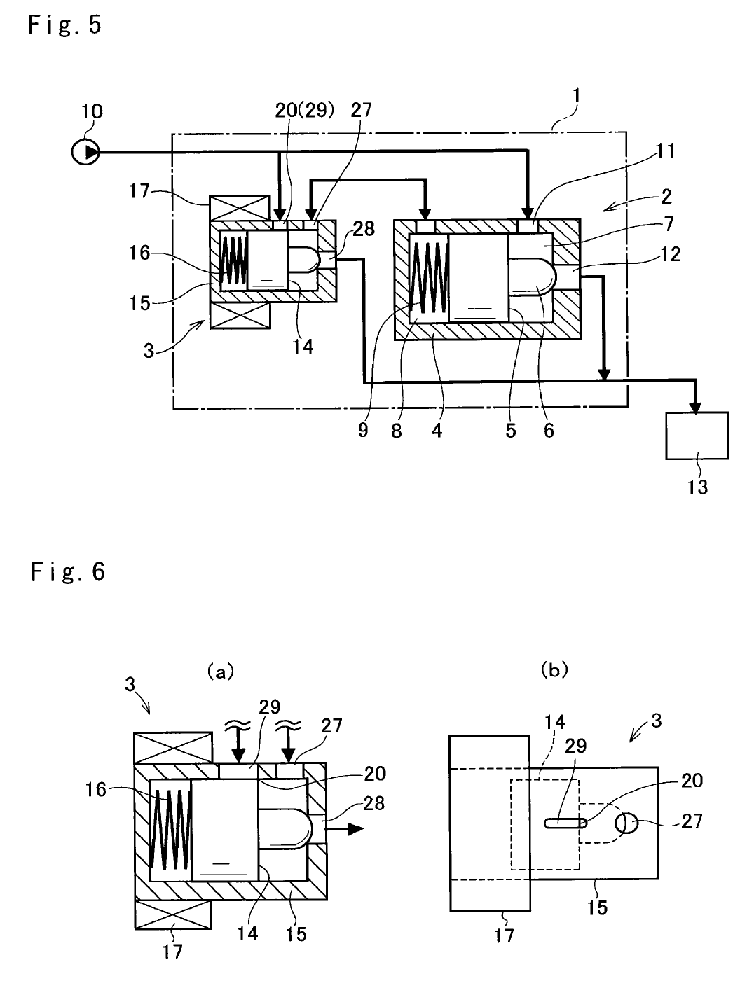

Next, here will be explained another example of the present invention. Turning to FIG. 5, there is shown an example in which the variable orifice is incorporated into the pilot valve 3. According to another example, the pilot valve 3 is adapted to always provide a communication between the back pressure chamber 8 and the positive pressure chamber 7 of the main valve 2 or the hydraulic source 10. To this end, according to the example shown in FIG. 5, the port of the example shown in FIG. 1 connected to the low pressure site such as the control object 13 is connected to the back pressure chamber 8. According to the example shown in FIG. 5, an inlet port 27 serving as the claimed second inlet port is connected to the back pressure chamber 8. In addition, an outlet port 28 opened and closed by the plunger 14 is connected to the low pressure site such as the control object 13. Accordingly, the outlet port 28 serves as the claimed second outlet port.

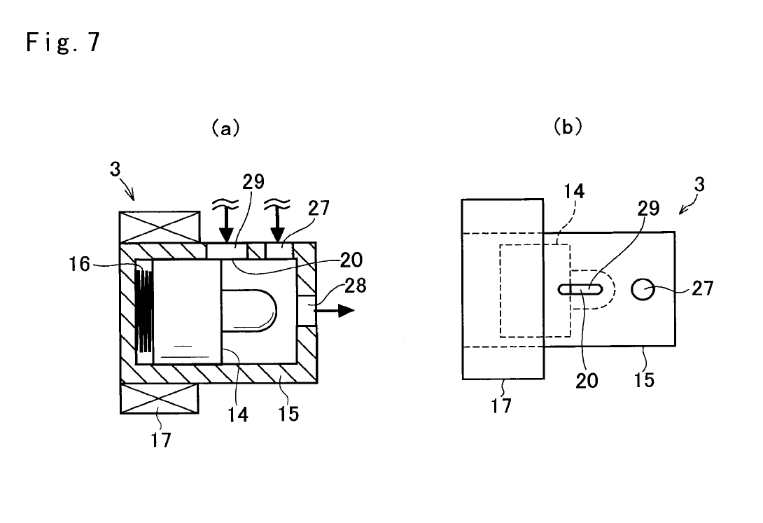

A third port 29 is formed on the pilot cylinder 15. Specifically, the third port 29 is opened to a space to which the inlet port 27 and the outlet port 28 are also opened, and connected to the back pressure chamber 8 or the hydraulic source 10. In addition, the third port 29 is formed at a position within a reciprocating range of the plunger 14 held in the pilot cylinder 15 so that an opening area thereof is changed by the plunger 14. As shown in FIGS. 6 and 7, the third port 29 is formed into a long hole extending in the reciprocating direction of the plunger 14. More specifically, as shown in FIG. 6, the third port 29 is formed at a position to be closed mostly but still opened slightly by moving the plunger 14 to the most anterior point. In other words, the third port 29 extends from a slightly in front of the leading end of the plunger 14 at the most anterior position toward a rear end side. By contrast, the opening area of the third port 29 is increased in accordance with withdrawal of the plunger 14 by the electromagnetic force. FIG. 7 shows a situation in which the third port 29 is fully opened.

As described, the third port 29 is opened to the inner space of the pilot cylinder 29 while being connected always to the inlet port 27 connected to the back pressure chamber 8, and the opening area thereof is reduced to restrict a flow rate of the oil flowing therethrough. Accordingly, the third port 29 serves as the aforementioned orifice 20, and the plunger 14 or the pilot valve 3 serves as the claimed orifice adjustment device.

Here will be explained an action of the example shown in FIGS. 5 to 7. When the pilot valve 3 is in off state, the plunger 14 is pushed forward by the spring 16 to close the outlet port 28. In this situation, most part of the third port 29 is closed by the outer circumferential face of the plunger 14 so that the opening area of the third port 29 is reduced to be the minimum area. The positive pressure chamber 7 and the back pressure chamber 8 of the main valve 2 are connected through the third port 29 and the inlet port 27. Therefore, the pressures in those chambers are equalized in this situation so that the main valve 2 is closed.

When the plunger 14 is withdrawn by energizing the electromagnetic coil 17, an overlap zone between the outer circumferential face of the plunger 14 and the third port 29 is reduced so that the opening area of the third port 29 toward the inner space of the pilot cylinder 15 is increased. In this situation, since the opening degree of the pilot valve 3 is increased, an discharging amount of the oil toward the low pressure site such as the control object 13 is increased. However, an amount of the oil flowing into the pilot cylinder 15 through the third port 29 is also increased. For this reason, the discharging amount of the oil from the back pressure chamber 8 of the main valve 2 is reduced so that pressure drop therein can be prevented.

Thus, according to the example shown in FIGS. 5 to 7, the opening degree of the orifice 20 is increased with an increase in the opening degree of the pilot valve 3 so that the pressure drop in the back pressure chamber 8 can be prevented. Therefore, the relation between the opening degree of the pilot valve 3 and the ratio of the control pressure to the upstream pressure (control pressure/upstream pressure) is adjusted to that in the hydraulic control valve 1 shown in FIG. 1 so that the controllability can be improved. In addition according to the example shown in FIGS. 5 to 7, the opening degree of the orifice 20 is changed depending on the electromagnetic force established by the pilot valve 3 or the position of the plunger 14 moved by the electromagnetic force. Therefore, even if the hydraulic pressure established by the hydraulic source 10 is fluctuated, the opening degree of the orifice 20 will not be changed by such fluctuation in the pressure so that the controllability can be improved within wide pressure range.

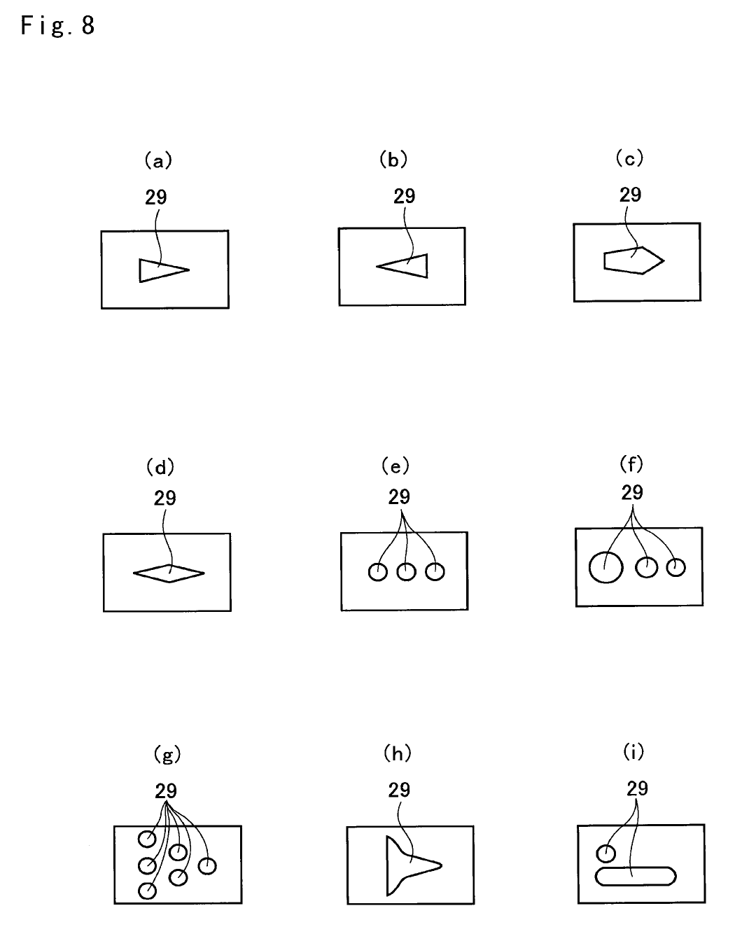

As described, according to the example shown in FIGS. 5 to 7, reduction in the pressure in the back pressure chamber 8 with respect to the opening degree of the pilot valve 3 is governed by a change in the opening degree of the orifice 20. Accordingly, hydraulic control characteristics may be adjusted according to need by changing a configuration of the third port 29 serving as the orifice 20 in such a manner that an opening width of the third port 29 is widened or narrowed in accordance with a stroke of the plunger 14. Turning to FIG. 8, there are shown modified example of the third port 29. In FIG. 8 (a), the third port 29 is formed into a triangle shape in which a base is situated in the spring 16 side; in FIG. 8 (b), the third port 29 is formed into a triangle of opposite orientation; in FIG. 8 (c), the third port 29 is formed into a pentagon shape extending in the axial direction; and in FIG. 8 (d), the third port 29 is formed into a rhombic shape extending in the axial direction. Given that the third port 29 is formed into those shapes, the opening area of the third port 29 is change gradually in accordance with a travel distance of the plunger 14 in the direction to open the valve. Specifically, the opening area of the third port 29 is increased or reduced gradually, or increased once and then decreased. In FIG. 8 (e), the third port 29 is formed into an array of circular holes having same inner diameter arranged in a stroke direction of the plunger 14; in FIG. 8 (f), the circular hole of the spring 16 side is diametrically increased; in FIG. 8 (g), number of the circular holes is gradually increased toward the spring 16 side; in FIG. 8 (h), a base portion of an obtuse triangle is joined to a leading end portion of an acute triangle; and in FIG. 8 (i), a long hole is combined with a circular hole. Given that the third port 29 is formed into those shapes, the opening area of the third port 29 serving as the orifice 20 is increased stepwise in accordance with a travel distance of the plunger 14 in the direction to open the valve and depending on the configuration. Thus, the configurations shown in FIG. 8 are formed in such a manner that an opening width in the circumferential direction of the pilot valve 15 is varied in the axial direction of the pilot valve 15. Therefore, the opening degree of the orifice 20 is changed in accordance with the stroke of the plunger 14.

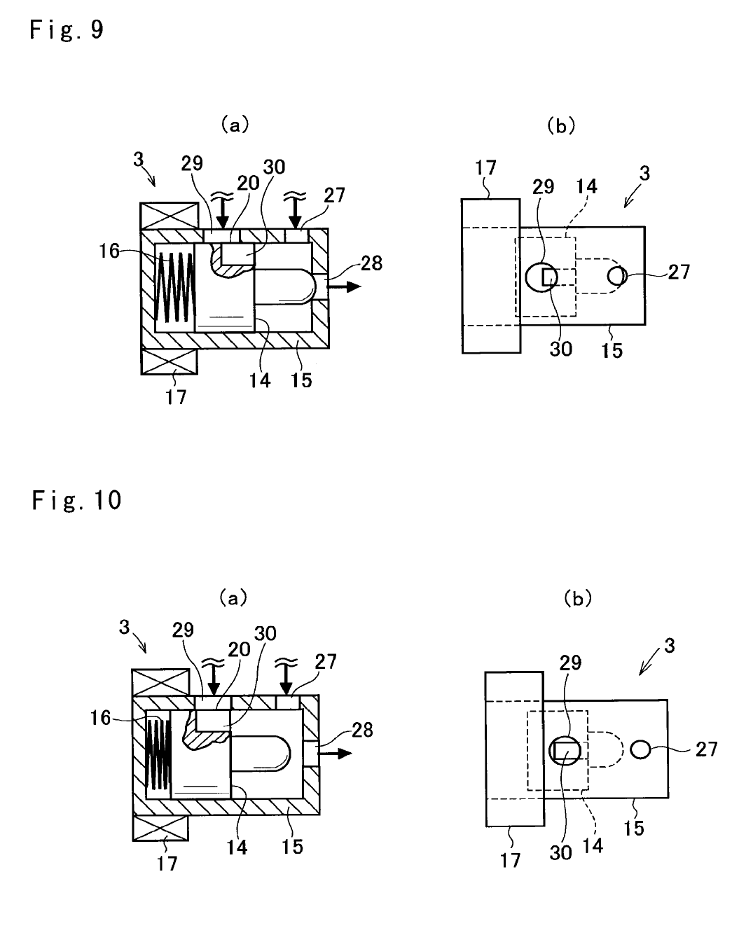

In order to use the pilot valve 3 as the variable orifice, it is also possible to form a flow passage on the outer circumferential face of the plunger 14 to vary the opening area of the third port 29. An example such structure is shown in FIGS. 9 and 10. According to the example shown therein, a groove 30 is formed on the outer circumferential face of the plunger 14 at a portion to be opposed to the third port 29. Specifically, the groove 30 is formed from the leading end of the plunger 14 (in opposite side of the spring 16) within a predetermined length. As shown in FIG. 9, when the plunger is situated at the most anterior point, the groove 30 is partially overlapped with the third port 29 to reduce the opening degree of the orifice 20 while maintaining a communication therebetween. The overlap zone between the groove 30 and the third port 29 is increased with a withdrawal of the plunger 14 to increase the opening area of the third port 29 serving as the orifice 20. Thus, same action as the hydraulic control valve 1 shown in FIGS. 5 to 7 may also be achieved by forming the groove 30 on the plunger 14.

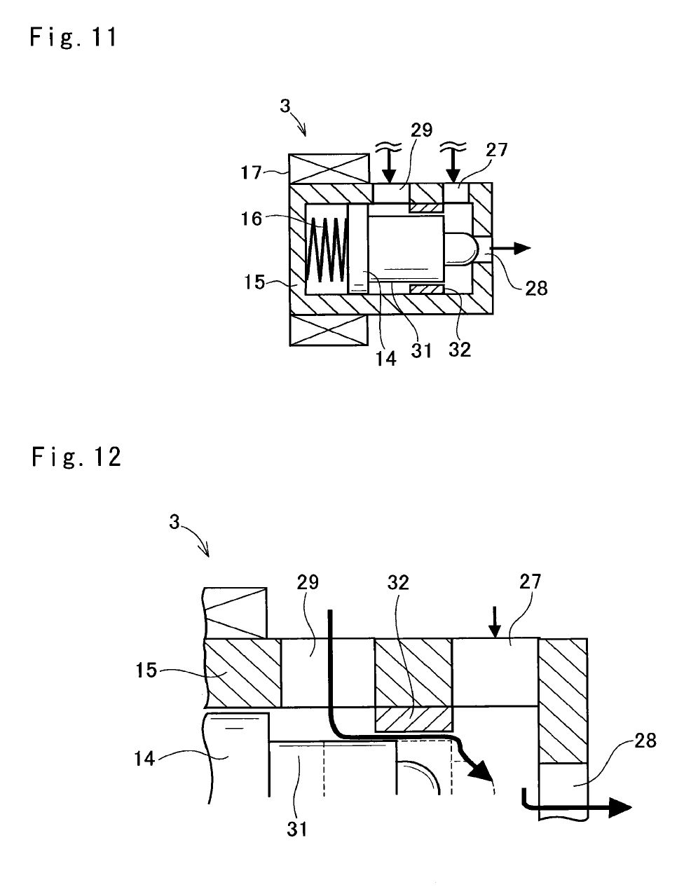

That is, the orifice 20 according to the present invention is adapted to reduce a flow rate of the oil at any point between the back presser chamber 8 and the positive pressure chamber 7 or the hydraulic source 10. To this end, the orifice 20 of the present invention or the adjuster device thereof should not be limited to the foregoing example to change the opening area of the port. For example, as shown in FIG. 11, it is also possible to change the opening area of the port by changing a length of a flow passage. In the example shown in FIG. 11, a variable orifice in which a length of a flow passage is changeable is formed in the pilot valve 3.

According to the example shown in FIG. 11, the plunger 14 of the pilot valve 3 is provided with a thin shaft 31 that is diametrically smaller than an inner diameter of the pilot cylinder 15. On the other hand, the pilot cylinder 15 is provided with a diametrically smaller portion 32 whose inner diameter is slightly larger than an outer diameter of the thin shaft 31 between the third port 29 and the inlet port 27. When the plunger 14 is situated at the most anterior point to close the valve, the diametrically smaller portion 32 is fully overlapped with the thin shaft 31, and in this situation, leading ends of those elements are aligned to each other. By contrast, when the plunger 14 is withdrawn, an overlap zone between the thin shaft 31 and the diametrically smaller portion 32 is reduced gradually. Eventually, when the plunger 14 is withdrawn to the most posterior point, the overlap zone between the thin shaft 31 and the diametrically smaller portion 32 is minimized.

That is, according to the example shown in FIG. 11, the thin shaft 13 of the plunger 14 is inserted completely into the diametrically smaller portion 32 when the pilot valve 3 is closed (i.e., in an off-state), and in this situation, a narrow clearance is created between an outer circumferential face of the thin shaft 13 and an inner circumferential face of the diametrically smaller portion 32. As described, the third port 29 is connected to the positive pressure chamber 7 or the hydraulic source 10, and the inlet port 27 is connected to the back pressure chamber 8. That is, the back pressure chamber 8 is connected to the positive pressure chamber 7 or the hydraulic source 10 through the above-mentioned clearance. Accordingly, the clearance serves as the orifice 20 of this example. In the example shown in FIG. 11, the third port 29 serves as the claimed “fourth port”, the inlet port 27 serves as the claimed “third inlet port”, and the outlet port 28 serves as the claimed “third outlet port”.

When the plunger 14 is withdrawn by the electromagnetic force of the electromagnetic coil 17 as illustrated in FIG. 12, an insertion length of the thin shaft 13 into the diametrically smaller portion 32 (i.e., an engagement length) is reduced gradually so that a length of the orifice 20 is reduced. The orifice is adapted to restrict a flow of liquid by a reduced cross-sectional area or an elongated high resistance area thereof. Therefore, when the engagement length between the thin shaft 13 and the diametrically smaller portion 32 is thus reduced, a restriction of the orifice 20 is eased. Thus according to the example shown in FIG. 11, the orifice 20 serves as the variable orifice, and the plunger 14 or the pilot valve 3 serves as the orifice adjustment device. According to the present invention, therefore, a definition of the “opening degree of the orifice” is a degree of restriction of liquid flow, and the “opening degree of the orifice” includes the opening area of the orifice and the length of the orifice.

Thus, according to the example shown in FIG. 11, the opening degree of the orifice 20 is small under conditions that the opening degree of the pilot valve 3 is small and the pressure in the back pressure chamber is not lowered significantly, and the opening degree of the orifice 20 is increased with an increase in the opening degree of the pilot valve 3. Therefore, a reduction rate of the pressure in the back pressure chamber 8 with respect to the opening degree of the pilot valve 3 can be reduced as compared to that of the case in which the opening degree of the orifice is constant. For this reason, controllability can be improved as the hydraulic control valve 1 of the foregoing examples.

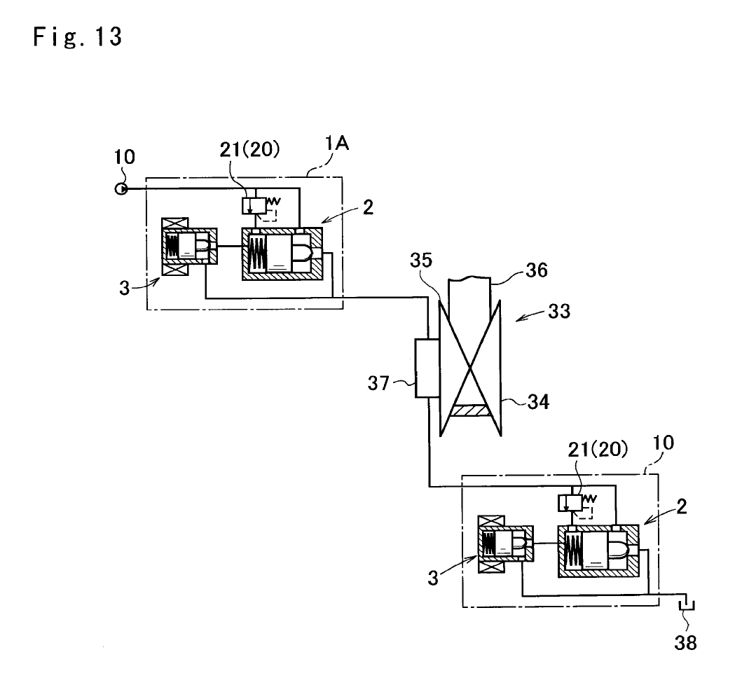

As explained in the foregoing examples, the hydraulic control valve 1 is adapted to control pressure in the high pressure site or the low pressure site by selectively allowing the oil to flow from the high pressure site to the low pressure site. Therefore, a desired operating condition can be maintained by confining the oil in the high pressure site, and it in unnecessary to always allowing the oil to flow. For these reasons, energy loss can be reduced. Such function can be utilized in a hydraulic control device for a belt-driven continuously variable transmission. Turning now to FIG. 13, there is shown an example in which the hydraulic control device according to the present invention is used as a feeding valve and a discharging valve of a belt-driven continuously variable transmission.

The belt-driven continuously variable transmission comprised a pair of pulleys and a belt running between those pulleys. In the belt-driven continuously variable transmission power is transmitted between those pulleys through the belt, and a speed ratio is varied continuously by changing a belt groove in the pulley to vary a running diameter of the belt. In FIG. 13, there is shown one of the pulleys 33. The pulley 33 comprises a fixed sheave 34 that is fixed in an axial direction, a movable sheave 35 that is allowed to reciprocate with respect to the fixed sheave 34, and a belt groove 36 formed between the sheaves 34 and 35. A hydraulic chamber 17 is formed on a back face of the movable sheave 35 so that the movable sheave 35 is pushed toward the fixed sheave 34 by the hydraulic pressure in the hydraulic chamber 37 to adjust the belt groove to a desired width or to adjust a belt clamping pressure to a desired value. An inlet port 12 of a hydraulic control valve 1A serving as a feeding valve is connected to the hydraulic chamber 37. On the other hand, an outlet port 11 of the hydraulic control valve 1D serving as the discharging valve is also connected to the hydraulic chamber 37 and to a drain site 38 such as an oil pan.

Pressure in the hydraulic chamber 37 can be raised by opening a main valve 2 of the hydraulic control valve 1A to deliver the oil from the hydraulic source 10 to the hydraulic chamber 37. By contrast, pressure in the hydraulic chamber 37 can be lowered by opening the hydraulic control valve 1D serving as the discharging valve. During controlling the pressure in the hydraulic chamber 37 by thus delivering and discharging the oil thereto/therefrom, an amount of change in the opening degree of the main valve 2 with respect to the current value applied to the pilot valve 3 will not be increased excessively even if the opening degree of the pilot valve 3 is small. Therefore, the pressure can be controlled in a stable manner while preventing an overshooting and a hunting. In addition, the pressure in the hydraulic chamber 37 can be maintained to a predetermined level by turning off both hydraulic control valves 1A and 1D. Consequently, main valves 2 of those control valves 1A and 1D are closed to confine the oil in the hydraulic chamber 37 so that an occurrence of oil leakage can be prevented. Therefore, energy loss can be reduced.

As described, the orifice is adapted to prevent a change in the hydraulic pressure by restricting a flow rate of the oil flowing therethrough. A withdrawal speed of the valve element 6 in the direction to open the main valve 2, and a travelling distance of the valve element 6 with respect to an amount of change in the control pressure can be reduced by suppressing a change in the pressure in the positive pressure chamber 7 of the main valve 2 utilizing such function of the orifice. Consequently, an opening degree of the pilot valve used to control hydraulic pressure can be widened so that the controllability can be improved.

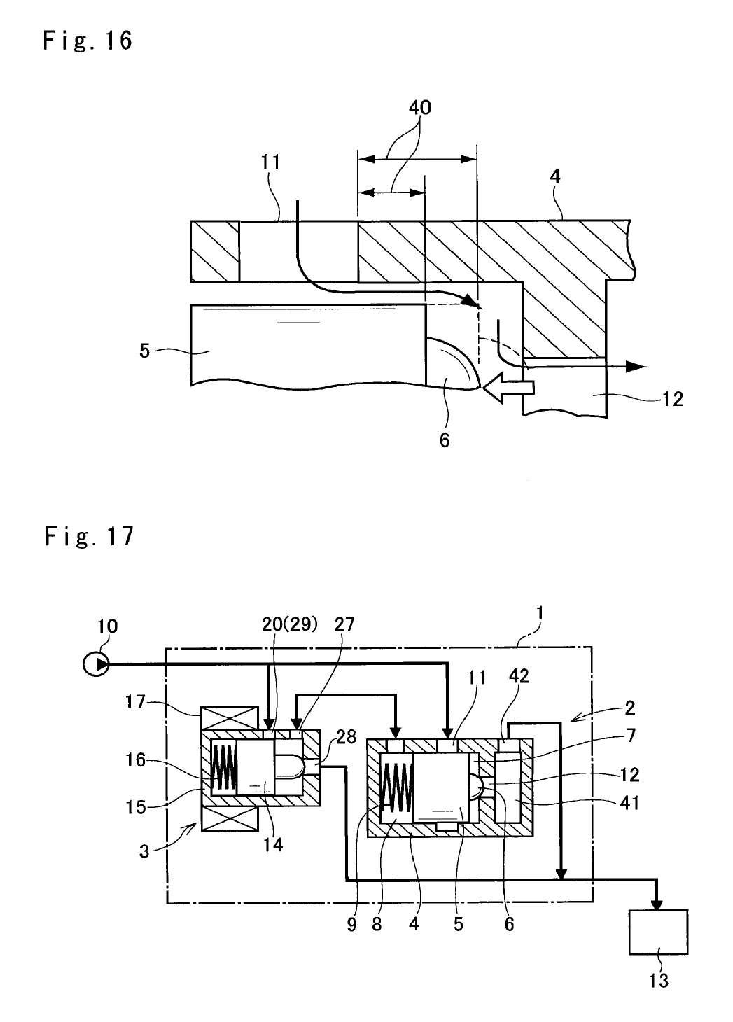

An example of such structure is shown in FIG. 15. In the example shown in FIG. 15, a clearance 40 between the outer circumferential face of the valve element 6 of the main valve 2 shown in FIG. 2 and the inner circumferential face of the cylinder 4 serves as an orifice. Specifically, the clearance 40 is formed in such a manner to have a cross-sectional area smaller than that of the inlet port 11. In this example, the inlet port 11 is situated at a position to be opposed to the outer circumferential face of the piston 5 while providing a communication with a clearance between the outer circumferential face of the piston 5 and the inner circumferential face of the cylinder 4, even when the piston 5 is withdrawn to isolate the valve element 6 from the outlet port 12. Accordingly, the clearance 40 serves as the claimed “another orifice” for establishing a flow resistance of the oil flowing toward the positive pressure chamber 7. As illustrated in FIG. 16, specifically, the clearance 40 from an opening edge of the inlet port 11 of the outlet port 12 side and the leading end of the piston 5 serves as the orifice 40. Therefore, a length of the clearance 40 serving as the orifice can be shortened to reduce the flow resistance of the oil by withdrawing the piston 5 integrated with the valve element 6.

In the example shown in FIG. 15, a sub-chamber 41 is formed on the inlet port 12 side. A connection port 42 is formed on the sub-chamber 15 to provide a communication between the sub-chamber 15 and the control object 13. Remaining structures of the example shown in FIG. 15 are similar to those of the example shown in FIG. 1, and detailed explanation for the common elements will be omitted by allotting common reference numerals thereto.

As shown in FIG. 17, the main valve 2 shown in FIG. 15 may be combined with the pilot valve 3 having a variable orifice to form the hydraulic control valve 1. That is, in the example shown therein, the main valve 2 shown in FIG. 5 is replaced with the main valve 2 shown in FIG. 15. Accordingly, in FIG. 17, common reference numerals are allotted to the element in common with those in the examples shown in FIGS. 5 and 15, and detailed explanation for the common elements will be omitted.

In the hydraulic control valve 1 shown in FIG. 15 or 17, change in the pressure in the back pressure chamber 8 is controlled by the orifice 20 whose opening degree or area is variable so that the controllability can be improved. In addition, pressure rise in the positive pressure chamber 7 can be suppressed by the clearance 40 in the main valve 2 serving as the claimed “another orifice”. Therefore, the controllability can be further improved.

The action of the hydraulic control valve thus structured will be explained hereinafter. When the electromagnetic coil 17 is energized to open the pilot valve 3, the back pressure chamber 8 is connected to the low pressure site such as the control object 13 so that the pressure in the back pressure chamber 8 is lowered. Consequently, the oil flows into the back pressure chamber 8 through the orifice 20. As described, an opening degree or an opening area of the orifice 20 is increased with an increase in an opening degree of the pilot valve 3 so that reduction in the control pressure can be prevented. Therefore, controllability can be improved.

As a result of opening the pilot valve 3, pressures in the back pressure chamber 8 and the positive chamber 7 are differentiated from each other. Consequently, a load pushing the piston 5 and the valve element 6 toward the positive pressure chamber 7 is reduced. Then, when the reduction in the load overwhelms a load closing the valve, the piston 5 is withdrawn toward the back pressure chamber 8 so that the valve element 6 is isolated away from the outlet port 12 to open the valve. Consequently, the oil is allowed to flow into the positive pressure chamber 7 from the inlet port 11, and further delivered to the control object 13 through the inlet port 12, the sub-chamber 41 and the connection port 42. In this situation, the flow rate of the oil is reduced by the clearance 40 between the outer circumferential face of the piston 5 and the inner circumferential face of the cylinder 4 so that the pressure in the positive pressure chamber 7 is prevented from being raised.

A balance between the loads applied to the piston 5 integrated with the valve element 6 can be expressed by the following expression:

Fs+Fp2=Fp1+Fp3;

where Fs is the load derived from the spring 9, Fp2 is the load derived from the pressure in the back pressure chamber 8, Fp1 is the load derived from the pressure in the positive pressure chamber 7, and Fp3 is the load derived from the pressure in the sub-chamber 41. As described, the hydraulic pressure is lowered by the clearance 40 when the valve is opened. Consequently, the pressure in the positive pressure chamber 7 is lowered to the pressure P4 that is lower than the upstream pressure P1. Accordingly, the load Fp1 pushing the piston 5 toward the back pressure chamber 8 by the pressure P4 of the pressure in the positive pressure chamber 7 can be expressed by the following expression:

Fp1=(Ap−As)·P4;

where Ap is a pressure receiving area of the piston 5 in the back pressure chamber 8, and As is a sealing area by the valve element 6. The load Fs of the spring 9 may also be expressed using a constant k of the spring 9 as the following expression:

Fs=s·k;

where s is a travel distance (i.e., a stroke) of the piston 5. The stroke s can be dissolved by assigning the constant k into the above-mentioned expression expressing the balance between the loads applied to the piston 5, as expressed by the following expression:

s=(Fp1−Fp2+Fp3)/k.

In the above-expression, “Fp1” is governed by the pressure P4 in the positive pressure chamber 7, and the pressure P4 is lowered to be lower than the upstream pressure P1 by the clearance 40 even if the upstream pressure P1 is high. Therefore, the stroke s required to make a balance between the loads applied to the piston 5 can be shortened as compared to a case in which the pressure is not lowered by the clearance 40.

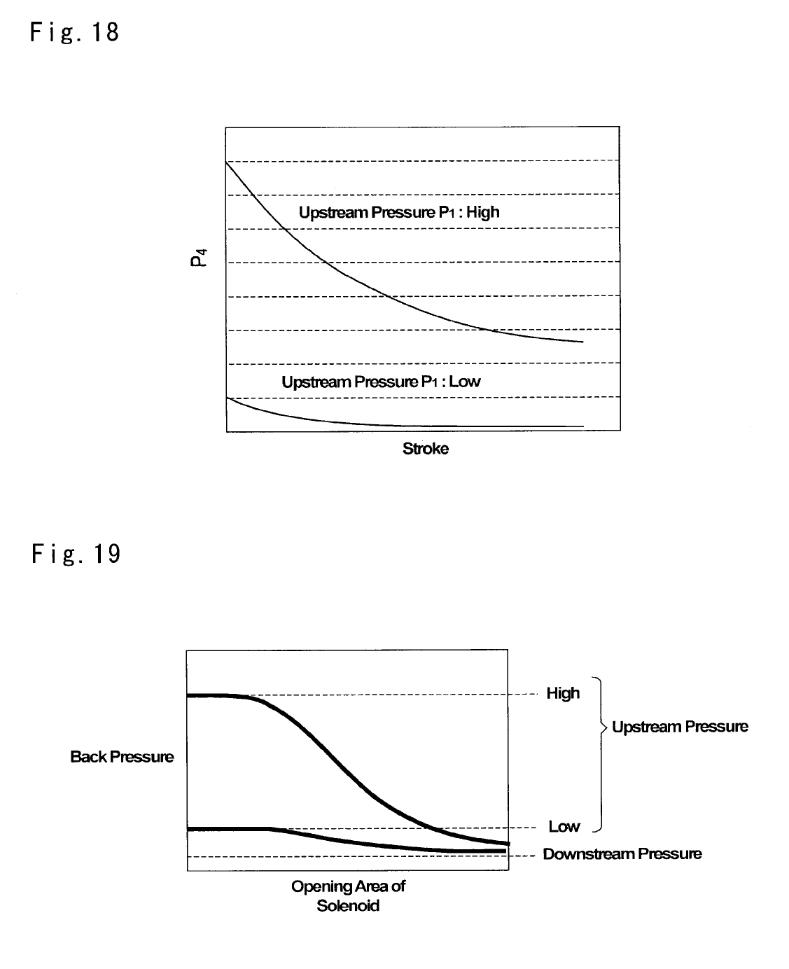

A relation between the pressure P4 in the positive pressure chamber 7 and the stroke s is indicated in FIG. 18. As can be seen from FIG. 18, even when the upstream pressure P1 established by the hydraulic source 10 is high, the pressure P4 in the positive pressure chamber 7 moving the piston 5 and the valve element 6 in the direction to open the valve is reduced significantly by the clearance 40. Therefore, an increment in the pressure difference as a motive force for moving the piston 5 and the valve element 6 can be suppressed.

As described, an opening degree of the pilot valve 3 is increased by increasing the current applied thereto to allow the oil to be discharged from the back pressure chamber 8, therefore, a pressure drop in the back pressure chamber 8 (i.e., a back pressure P2) is increased with an increase in the current value. A tendency of such pressure drop is indicated in FIG. 19. As can be seen from FIG. 19, when the current value applied to the pilot valve 3 is small so that the opening area of the pilot valve 3 is small, reduction in the pressure in the back pressure chamber 8 is prevented by the pilot valve 3 and hence the pressure difference is small. Then, when the opening area is increased with an increase in the current value, resistance between the back pressure chamber 8 and the low pressure site connected thereto is reduced so that the pressure in the back pressure chamber 8 is further lowered. That is, the back pressure P2 is lowered significantly with an increment in the upstream pressure P1.

Thus, the pressure difference for moving the piston 5 and the valve element 6 in the direction to open the valve is increased by increasing the current value. This means that the current value and the flow rate through the feeding valve are related to each other and hence the flow rate through the feeding valve can be controlled by the current applied to the pilot valve 3. Specifically, when the current value applied to the pilot valve 3 is increased, the above-mentioned pressure difference is increased so that the flow rate is increased with such increment in the current value as indicated in FIG. 20. When the upstream pressure P1 is relatively low, the pressure difference is also reduced and hence an increasing rate of the flow rate with respect to the current valve is reduced. That is, the flow rate is increased gradually. In addition, in the hydraulic control valve according to the present invention, the pressure P4 in the positive pressure chamber 7 is lowered by the flow resistance created by the clearance 40, even if the upstream pressure P1 is high and hence the pressure difference is increased. Therefore, the pressure difference will not be increased abruptly, and the piston 5 and the valve element 6 can be prevented from being moved abruptly. For these reasons, the increasing rate of the flow rate is reduced as shown in FIG. 19. In FIG. 20, flowing characteristics under conditions that the clearance 40 is not available and that the pressure difference is large is indicated by a broken line for comparison. Given that the clearance 40 serving as an orifice is not available, the pressure in the positive pressure chamber 7 is governed only by the upstream pressure P1 and hence the pressure difference or the load for moving the piston 5 and the valve element 6 is increased abruptly. As a result, the flow rate is increased abruptly.

According to the present invention, a change rate of the flow rate of the oil with respect to a change in the current value for opening the valve can be reduced even when high pressure is applied to the inlet port 11 of the hydraulic control valve 1 as a balance piston valve. Therefore, a relation between the current value and the flow rate can be stabilized to improve the controllability irrespective of a pressure level.

Turning to FIG. 21, there is shown a relation between the control pressure applied to the main valve 2 and a stroke of the valve element 6. In FIG. 21, the line “L1” is a characteristic line of a case in which the clearance 40 serving as an orifice is available, and the line “L2” is a characteristic line of a case in which the clearance 40 serving as an orifice is not available. As can be seen from FIG. 21, the control pressure is raised to the maximum level to be equalized to the pressure in the positive pressure chamber 7 under the condition indicated as “pilot is fully closed”. When the plunger of the pilot valve 3 is withdrawn by the electromagnetic force, the control pressure is changed (i.e., lowered) in the direction indicated by the arrow represented as “pilot stroke”. As indicated by the characteristic line L1, according to the example in which the clearance 49 serving as an orifice is available, an increasing rate of the stroke of the valve element 6 of the main valve 2 with respect to the reduction in the control pressure is reduced to be smaller than that of the case (in which the orifice 40 is not available) represented by the characteristic line L2. Thus, a range of the control pressure can be widened by forming the clearance 40 serving as an orifice in the main valve 2.

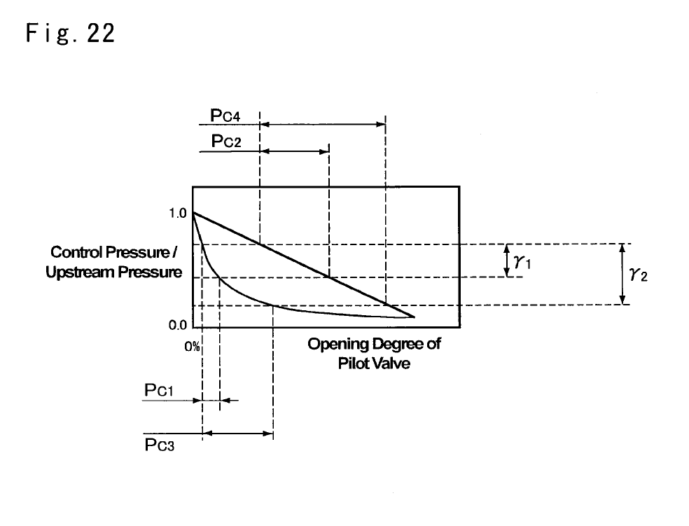

As shown in FIG. 22, the range of the control pressure can be indicated in the above-explained FIG. 14. As described, the range of the control pressure can be widened by forming the clearance 40 serving as an orifice as compared to the case in which the clearance 40 is not available. Accordingly, a usable range of the ratio between the control pressure and the upstream pressure (control pressure/upstream pressure), that is, an operating range of the main valve falls within a range represented by “Γ1” in case the clearance 40 is not available, and falls within a range represented by “Γ2” in case the clearance 40 is available. As described, given that the opening degree of the orifice connected to the back pressure chamber 8 is constant, the ratio between the control pressure and the upstream pressure is indicated by the downwardly depressed curve in FIG. 22. By contrast, in the hydraulic control valve having the orifice 20 whose opening degree is variable, such ratio is indicated by the substantially straight line L. That is, in the conventional valve in which the opening degree of the orifice is constant and which is not provided with the clearance 40, the range of opening degree of the pilot valve for controlling the hydraulic pressure is restricted within a narrow range represented by “Pc1”. By contrast, if the valve is not provided with the clearance 40 but provided with the orifice 20 whose opening degree is variable, the range of opening degree of the pilot valve for controlling the hydraulic pressure is widened to be wider than that of the conventional valve as represented by “Pc2”.

Given that the control valve is not provided with the orifice 20 whose opening degree is variable but provided with the clearance 40, the range of opening degree of the pilot valve for controlling the hydraulic pressure is further widened as represented by “Pc3”. Given that the hydraulic control valve is provided with both the orifice 20 whose opening degree is variable and the clearance 40, the range of opening degree of the pilot valve can be further widened to be widest range as represented by “Pc4”. That is, controllability of the hydraulic control valve 1 can be further improved by the action of the orifice 20 whose opening degree is variable and the action of the clearance 40 serving as an orifice.

“Another orifice” of the present invention for restricting a flow rate of the oil delivered to the positive pressure chamber 7 should not be limited to the clearance 40, and it may also be formed on the oil passage connected to the inlet port 11. Instead, “another orifice” may also be formed by reducing a diameter of the inlet port 11 itself. Further, “another orifice” may also be formed by forming a diametrically-small through hole penetrating through the piston 6 to provide a communication with the end face of the positive pressure chamber 7. In addition, a clearance serving as an orifice like the clearance 40 may also be formed between an outer circumferential face of a diametrically-smaller portion additionally formed on an outer circumferential face of the valve element 6 of the piston 5 and an inner circumferential face of the diametrically-smaller portion. In this case, an engagement length between the valve element and the diametrically-smaller portion may be set to be shorter than the entire travel distance of the piston and the valve element from the point to close the valve completely and to the point to open the valve completely, so as to disengage the valve element from the diametrically-small portion before the piston is withdrawn to the position to open the valve completely.

Optionally, in the hydraulic control valve in which the opening area of the inlet port 11 is varied in accordance with the travel distance of the piston 5, the inlet port 11 may be opened completely when the piston 5 is moved further than a predetermined range, in order not to restrict the flow rate of the oil by another orifice.

In addition, in the hydraulic control valve in which the inlet port 11 is connected to the clearance 40 serving as an orifice, configuration of the inlet port 11 may by modified to the configurations shown in FIG. 8 so as to vary the opening width thereof in the axial direction of the cylinder.

### REFERENCE SIGNS LIST

1, 1A, 1D: hydraulic control valve; 2: main valve; 3: pilot valve; 4: cylinder; 5: piston; 6: valve element; 7: positive pressure chamber; 8: back pressure chamber; 9: spring; 10: hydraulic source; 11: inlet port; 12: outlet port; 13: control object; 14: plunger; 15: pilot cylinder; 16: spring; 17: electromagnetic coil; 18: inlet port; 19: outlet port; 20: orifice; 21: spool valve; 22a, 22b land portion: 23: cylinder; 22: spool; 24: spring; 25: inlet port; 26: outlet port; 27: inlet port; 28: outlet port; 29: third port; 30: groove; 31: thin shaft; 32: diametrically smaller portion; 33: pulley; 34: fixed sheave; 36: belt; 37: hydraulic chamber; 38: drain site; 40: clearance (another orifice).

1. A hydraulic control valve, comprising:
a piston held in a cylinder while being allowed to reciprocate in an axial direction;
a positive pressure chamber formed on one side of the piston in the cylinder while being connected to a first inlet port and a first outlet port;
a back pressure chamber formed on the other side of the piston;
a valve element formed on the piston to open and close the first outlet port;
an orifice arranged between the positive pressure chamber and the back pressure chamber;
a pilot valve that selectively provides a connection between the back pressure chamber and a site at which pressure therein is lower than that in the back pressure chamber;
wherein the first inlet port is connected to a high pressure site; and
wherein the first outlet port is connected to a low pressure site at which a pressure therein is lower than that in the high pressure site;
the hydraulic control valve further comprising:
an orifice adjustment device that adjusts an opening degree of the orifice based on a condition of pressure drop in the back pressure chamber.

2. The hydraulic control valve as claimed in claim 1, wherein the orifice adjustment device is adapted to reduce restriction of oil by the orifice with an increase in a pressure difference between the back pressure chamber and the positive pressure chamber.

3. The hydraulic control valve as claimed in claim 1,
wherein the orifice adjustment device comprises: a first port connected to the positive pressure chamber; a second port connected to the back pressure chamber; and an adjuster valve element to which pressures from the positive pressure chamber and the back pressure chamber are applied to counteract each other, and which is moved upon exceedance of a difference between the pressures applied thereto to increase an opening area of the first port or the second port in accordance with the pressure difference, and
wherein the orifice is formed by any of the first port and the second port in which the opening area thereof is changed by the adjuster valve element.

4. The hydraulic control valve as claimed in claim 1,
wherein the pilot valve comprises: a plunger that is axially reciprocated by an electromagnetic force; a pilot cylinder holding the plunger therein; a second inlet port that is opened to an inner circumferential face of the pilot cylinder while being connected to the back pressure chamber; a second outlet port that is opened to one of axial ends of the pilot cylinder while being connected to the low pressure site, and that is opened and closed by the plunger; and a third port that is opened to the inner circumferential face of the pilot cylinder while being connected to the positive pressure chamber,
wherein the orifice is formed by partially overlapping the plunger with any one of the second inlet port and the third port to reduce an opening degree thereof, and
wherein the orifice adjustment device is adapted to reduce the opening degree of the orifice by axially moving the plunger overlapped partially with any one of the second inlet port and the third port.

5. The hydraulic control valve as claimed in claim 4, wherein an opening width of any one of said ports differs in an reciprocating direction of the plunger.

6. The hydraulic control valve as claimed in claim 1,
wherein the pilot valve comprises: a plunger that is axially reciprocated by an electromagnetic force; a pilot cylinder holding the plunger therein; a third inlet port that is opened to an inner circumferential face of the pilot cylinder while being connected to the back pressure chamber; a third outlet port that is opened to one of axial ends of the pilot cylinder while being connected to the low pressure site, and that is opened and closed by the plunger; and a fourth port that is opened to the inner circumferential face of the pilot cylinder while being connected to the positive pressure chamber,
wherein the orifice includes a clearance between a portion of the inner circumferential face of the pilot cylinder and a portion of the outer circumferential face of the plunger that is situated between the third inlet port and the fourth port; and
wherein the orifice adjustment device is adapted to change a length of the clearance by axially moving the plunger.

7. The hydraulic control valve as claimed in claim 1, further comprising:
another orifice adapted to restrict a flow rate of oil flowing into the positive pressure chamber from the high pressure site through the first inlet port.

8. The hydraulic control valve as claimed in claim 7,
wherein the piston and the valve element are allowed to be moved between a position to fully close the first outlet port and a position to fully open the first outlet port,
wherein said another orifice is adapted to restrict a flow rate of the oil flowing into the positive pressure chamber from the first inlet port within a predetermined range before the piston and the valve element reach the position to fully open the first outlet port, and
wherein said another orifice does not restrict a flow rate of the oil flowing into the positive pressure chamber from the first inlet port when the piston and the valve are moved further than the predetermined range.

9. The hydraulic control valve as claimed in claim 7, wherein said another orifice is adapted to reduce restriction of the oil by increasing an opening degree thereof in accordance with a traveling distance of the piston and the valve element in a direction to open the first outlet port.

10. The hydraulic control valve as claimed in claim 9, wherein said another orifice is adapted to be fully opened so as not to restrict a flow rate of the oil by moving the piston and the valve element predetermined distance in the direction to open the first outlet port.

11. The hydraulic control valve as claimed in claim 7, wherein said another orifice includes a clearance formed between the outer circumferential face of the piston and the inner circumferential face of the cylinder that allows the oil to flow therethrough toward the positive pressure chamber.

12. The hydraulic control valve as claimed in claim 7,
wherein the piston comprises a base portion that is brought into contact to the inner circumferential face of the cylinder in a liquid-tight manner, and a protruding portion that is diametrically smaller than the base portion and that protrudes from the base portion toward the positive pressure chamber;
wherein the positive pressure chamber comprises a diametrically smaller portion that is overlapped with a leading end portion of the protruding portion within a predetermined range; and
wherein said another orifice is formed between an outer circumferential face of the protruding portion and an inner circumferential face of the diametrically smaller portion.

13. The hydraulic control valve as claimed in claim 12, wherein an overlap zone between the protruding portion and the diametrically smaller portion is shorter than the travel distance of the piston and the valve element from the position to fully close the first outlet port and the position to fully open the first outlet port.

14. The hydraulic control valve as claimed in claim 7,
wherein said another orifice is formed by an opening end of the first inlet port opening to the positive pressure chamber, and the outer circumferential face of the piston that is partially overlapped with the opening end to reduce an opening area of the opening end; and
wherein an opening width of the opening end in a circumferential direction of the cylinder differs in an axial direction of the cylinder.

15. The hydraulic control valve as claimed in claim 7, wherein said another orifice includes a groove that is formed on the outer circumferential face of the piston while being opened to the first inlet port and the positive pressure chamber.

16. The hydraulic control valve as claimed in claim 7, wherein said another orifice includes a through hole penetrating through the piston while being opened to the first inlet port and the positive pressure chamber.

17. A hydraulic control device, comprising:
a feeding valve that controls oil delivered from a hydraulic source to a hydraulic chamber of a pulley on which a belt is applied; and
a discharging valve that controls the oil discharged from the hydraulic chamber,
wherein the hydraulic control valve as claimed in claim 1 is used as at least any of the feeding valve and the discharging valve.
